(19) United States
(12) Patent Application Publication
(10) Pub. No.: US 2009/0265182 A1
(43) Pub. Date: Oct. 22, 2009

(54) Method and system for point-of-dispensing management of anticoagulation agent therapy

(76) Inventors: Brent W. Peterson, Mount Pleasant, UT (US); Allen M. Day, Fairview, UT (US); Charles E. Nunn, Ephraim, UT (US)

Correspondence Address: DINESH AGARWAL, P.C., 5350 SHAWNEE ROAD, SUITE 330, ALEXANDRIA, VA, 22312, US

(21) Appl. No.: 12/081,794

(22) Filed: Apr. 22, 2008

(51) Int. Cl. G06Q 50/00

(52) U.S. Cl. 705/2

(57) ABSTRACT

A method and system for point-of-dispensing, point-of-sale, or retail pharmacy management of an anticoagulation agent therapy for a subject, includes reviewing an anticoagulation regimen and obtaining data for a subject relating to anticoagulation therapy, determining an International Normalized Ratio (INR) level for the subject, determining any potential interaction of the anticoagulation agent with one or more non-anticoagulation agents that the subject intends to take or is taking, evaluating in real time any need to adjust the anticoagulation regimen, and adjusting in real time, if needed, the anticoagulation regimen based on one or both INR level and any interaction determinations, to maintain the subject's INR level within a desired range.

### FIELD AND BACKGROUND OF THE INVENTION

The present invention is generally directed to a drug therapy management system, and more particularly to a method and system for point-of-dispensing or point-of-sale management of an anticoagulant agent therapy.

Anticoagulation agents including warfarin (Coumadin®), heparin (unfractionated), and low-molecular weight heparin (LMWH), and other anti-coagulants are commonly used agents in the United States health care system. They act as an anticoagulants for those with a known clotting disorder or those at high risk for a blood clot. Although these agents do not actually change the viscosity of the blood, they do change the body's ability to form clots and are, therefore, commonly referred to as “blood thinners.” Many common conditions, some of which include a deep venous thrombosis (DVT), atrial fibrillation (AF), cerebrovascular accident (CVA), transient ischemic attack (TIA), Protein C or S deficiency, status post orthopedic surgeries, such as knee or hip arthroplasty, heart valve replacement and repair (whether cadaver, porcine or porceline), pulmonary embolism (PE), and pelvic fractures, often require anticoagulant therapy. Many of these conditions can be fatal, if not treated appropriately with an anticoagulation agent.

Even though anticoagulants are life saving agents for many people, they are also one of the most dangerous agents prescribed in the modern health care system. In fact, warfarin, the most commonly used anticoagulant, is the main ingredient in rat poison. Warfarin prevents coagulation of the rat's blood and allows the rat to bleed to death from trauma as it distorts its body to crawl through crevices. Similarly in humans, simple daily activities can become lethal if the anticoagulant is overdosed.

Unlike most drugs currently prescribed, anticoagulants have a narrow therapeutic window and do not conform to general population based dosing guidelines making them difficult to manage. Often multiple anticoagulants are combined initially in treatment, with most patients being transitioned to oral warfarin therapy for long term management. Heparin must be dosed individually and requires hour-to-hour management, and can only be managed with a blood test called “Partial Thromboplastin Time (PTT).” Low-molecular weight heparin is safer and requires less monitoring, but if testing is needed, a separate blood test of Factor Xa is required. When managing warfarin, each patient's dose is unique and can only be monitored by a blood test called “Prothrombin Time/International Normalized Ratio (PT/INR).”

When using warfarin as an anticoagulant, a bridging medication is typically required. This is because warfarin has a delayed onset and effect, requiring other agents to bridge or compensate for the delay in action, when warfarin is started or held, during or after a surgical or dental intervention. Most commonly used bridging agents, include heparin and LMWH, which have an immediate action but are also very dangerous and require vigilant monitoring.

When a patient's warfarin is dosed too high, they are prone to bleed easily from their intestines, nose, genitourinary system, brain, and into the skin and muscle, with very little and sometimes no trauma. If warfarin is dosed too low, the patient is susceptible to blood clots that may cause strokes, heart attacks, and pulmonary embolisms. As a result, warfarin needs to be monitored very carefully by the PT/INR blood test.

Changes in warfarin dose are made based on whether the INR is too high or too low. Complicating factors of warfarin therapy, include a myriad of drug-to-drug interactions that both raise and lower the INR based on the drug interaction, including common agents, such as antibiotics, pain relievers (Aspirin®, Tylenol®, Ibuprofen®, etc.), cough and cold preparations, and diabetes and heart medicines, and allergy medicines, among others. Additionally, many over-the-counter (OTC) medicines, herbal remedies, and dietary supplements that are purchased freely by people, interact with warfarin. The therapy is further complicated by many food items that interact with warfarin and other anticoagulation agents.

### United States Anticoagulation Adverse Event Data

Currently, the standard of care in anticoagulation agent management is lacking. The following data shows the adverse effects of anticoagulation-related events in the U.S.
1) The average cost for a single anticoagulation-related hemorrhagic event exceeds $10,000 per claim. (Managed Care Q. 2006 Winter:14(1):13-6 (Abstract Only).
2) The average cost per hospitalization for anticoagulation related bleeding is $15,988, with an average hospital stay of six days according to a study published in the American Journal of Cardiology. (American Journal of Cardiology. Aug. 15, 2005: Vol. 96 (Issue 4). Pg 595-8.
3)
   a) The number of dispensed out-patient warfarin prescriptions increased by 45% from 1998 to 2004. It went from 21 million to 31 million prescriptions during this time frame. With the same estimated growth for the past 3 years it would be nearly 39.5 million in 2007.
   b) From US death certificates, anticoagulants ranked first for two years (2003 and 2004) for the cause of death related to “adverse effects in therapeutic use”.
   c) Hospital data for 1999 through 2003 showed that warfarin was the cause of 29,000 emergency department visits for bleeding complications per year.
   d) Literature consistently reports that major bleeding frequencies for patients on warfarin therapy are as high as 10% to 16%, which is in direct contrast to much lower serious adverse reactions with most drugs (< 1/1000 or <0.1%).
   e) From 1993 to July 2006, 9,766 US bleeding cases were reported due to warfarin therapy. Of these cases, 8,415 (86%) had a serious outcome including 10% of which were fatal. This is again in direct contrast to all other adverse reactions related to other drugs for which during the same time period only 30% had a serious outcome.
   f) Use of warfarin has and is increasing at a large rate and bleeding complications from warfarin use is a prevalent reaction and important cause of mortality. (Archives of Internal Medicine. Jul. 9, 2007:Vol 167 (No. 13)).
4)
   a) In a study of 42,451 patients and 1,2500,000 INRs it was noted that the death rate doubled with each unit of INR increase above 2.5. On the other hand, the risk of stroke (due to blood clot) doubled with INR's of 1.7 compared to 2.0. This demonstrates the very narrow therapeutic parameters for warfarin anticoagulation. (American Journal of Cardiology Aug. 1, 2004:Vol 94 (Issue 3). Pg. 403-6.

### BRIEF SUMMARY OF THE INVENTION

The present summary is provided to illustrate a few non-limiting, non-restrictive concepts that are further shown or described below in the drawings and the detailed description. The noted concepts are not limited to the main features of the claimed subject matter, nor are intended to be used as an aid in determining the scope of the claimed subject matter.

The present invention is generally directed to a method and system for point-of-dispensing management of an anticoagulation agent therapy, wherein the agent can be one or more of warfarin (Coumadin®), a Factor Xa inhibitor, an antiplatelet drug, Aspirin®, heparin, a low molecular weight heparin or other anticoagulant.

The present invention is further generally directed to a method and system for point-of-sale management of an anticoagulation agent therapy, wherein the agent can be one or more of warfarin (Coumadin®), a Factor Xa inhibitor, an antiplatelet drug, Aspirin®, heparin, a low molecular weight heparin or other anticoagulant.

The present invention is further directed to a method and system for management of an anticoagulation agent in a setting which takes a proactive approach to anticoagulation therapy and related services.

The present invention is further directed to a method and system for management of an anticoagulation agent by a clinic based in a retail pharmacy setting for real time monitoring and/or intervention of any and all drug-drug, drug-disease, drug-food, drug-food or dietary supplement, drug-allergy, drug-age, drug-gender, etc., interactions or complications.

The present invention is further directed to a method and system for management of an anticoagulation agent in a setting, wherein a pharmacist not only dispenses the anticoagulation agent, but also actively participates in the overall anticoagulation therapy by evaluating and/or assessing anticoagulation-related complications and contraindications with all medications (both prescription and over-the-counter), food, or other dietary and herbal supplements, testing and/or monitoring, in real time, the INR level for a patient, and intervening, if necessary, to bring or maintain the patient's INR level within a desired range by, for example, adjusting or modifying the anticoagulation agent regimen. Active participation by the pharmacist, reduces or eliminates other complications due to undesirable INR levels or other effects of the anticoagulation agent. For instance, lower and higher INR levels may result in blood clotting and bleeding, respectively, either of which may lead to deep vein thrombosis (DVT), pulmonary embolism (PE), stroke, bleeding, or death.

The present invention is further directed to a method and system for management of an anticoagulation agent in a retail pharmacy setting, wherein a pharmacist is authorized to make independent decisions for overall management of anticoagulation therapy by, for example, changing or modifying the prescription by a physician or other medical practitioner, reverse anticoagulant therapy, initiate and/or renew the anticoagulation prescription, authorize or perform laboratory draws for INR and serum creatinine, educate and reinforce the patient, notify the referring physician or medical practitioner the overall progress, and issue therapy-related reports.

The present invention is further directed to a method and system for management of an anticoagulation agent in a retail or pharmacy setting, wherein dispensing or sale of the anticoagulation agent, as well as all other medications (prescription and OTC), present and future, and all other dietary or herbal supplements, medicines, etc., and the overall anticoagulation agent therapy for a patient, is monitored by, or at the direction of, a pharmacist to evaluate and determine, in real time, any complications or contraindications for real time “intervention.” A non-limiting, general definition of the term “intervention,” includes a change in the dosage and/or administration of the anticoagulation agent, and/or overall therapy regimen to prevent or correct a complication due, for example, to an interaction with other agents, or to other conditions.

The present invention is further directed to a method and system for management of an anticoagulation agent therapy in a point-of-dispensing, point-of-sale, or retail pharmacy setting, which results in or produces useful, tangible, and concrete result in the form of improved physical and mental health of a subject. In particular, by following the present method and/or employing the present system, a subject's risks of adverse health-related complications are greatly reduced or eliminated. Additionally, unnecessary patient morbidity and mortality is greatly reduced or prevented. Likewise, unnecessary economic loss associated with anticoagulation agent therapy-related complications is greatly reduced or avoided.

In accordance with the above, a method for point-of-dispensing management of an anticoagulation agent therapy for a subject, includes reviewing an anticoagulation regimen and obtaining data for a subject relating to anticoagulation therapy, determining an International Normalized Ratio (INR) level for the subject, determining any potential interaction of the anticoagulation agent with one or more non-anticoagulation agents that the subject intends to take or is taking, evaluating in real time any need to adjust the anticoagulation regimen, and adjusting in real time, if needed, the anticoagulation regimen based on one or both INR level and any interaction determinations, to maintain the subject's INR level within a desired range.

Further, in a point-of-sale establishment, a method of managing an anticoagulation agent therapy for a subject, includes reviewing an anticoagulation regimen prescribed by a health care practitioner for a subject, enrolling the subject into an anticoagulation therapy program, the program including dispensing of an anticoagulation agent, as well as one or more non-anticoagulation agents that the subject intends to take or is taking, assessing any sign or symptom of anticoagulation therapy-related complication in the subject, determining any potential interaction of the anticoagulation agent with one or more non-anticoagulation agents, evaluating in real time any need to adjust the anticoagulation regimen prescribed by the health care practitioner based on one or both anticoagulation therapy-related and non-anticoagulation agent-related complications, and adjusting in real time, if needed, the anticoagulation regimen to maintain the subject's INR level within a desired range.

Further, a retail pharmacist-managed, anticoagulation agent therapy method for a subject, includes reviewing an anticoagulation regimen prescribed by a health care practitioner for a subject, enrolling the subject, into an anticoagulation therapy program, the program including dispensing of an anticoagulation agent, as well as one or more non-anticoagulation agents that the subject intends to take or is taking while in the program, conducting a test to determine whether an International Normalized Ratio (INR) level for the subject is sub-therapeutic, therapeutic, or supra-therapeutic, assessing any sign or symptom of anticoagulation therapy-related complication in the subject, determining any potential interaction of the anticoagulation agent with one or more non-anticoagulation agents, evaluating in real time any need to adjust anticoagulation regimen prescribed by the health care practitioner based on one or more of INR level, and anticoagulation therapy-related and non-anticoagulation agent-related complications, and adjusting, if needed, at the discretion of the pharmacist, the anticoagulation regimen to maintain the INR level subject's within a desired range.

Further, a method for point-of-dispensing management of an anticoagulation agent therapy for a subject who has already been enrolled in the therapy program, includes determining an International Normalized Ratio (INR) level for the subject, determining any potential interaction of the anticoagulation agent with one or more non-anticoagulation agents that the subject intends to take or is taking, evaluating in real time any need to adjust the anticoagulation regimen or therapy, and adjusting in real time, if needed, the anticoagulation regimen or therapy based on one or both INR level and any interaction determinations, to maintain the subject's INR level within a desired range.

Further, in a point-of-sale establishment, a method of managing an anticoagulation agent therapy for a subject who has already been enrolled in the therapy program, includes assessing any sign or symptom of anticoagulation therapy-related complication in the subject, determining in real time any potential interaction of the anticoagulation agent with one or more non-anticoagulation agents, evaluating in real time any need to adjust the prescribed anticoagulation regimen or therapy based on one or both anticoagulation therapy-related and non-anticoagulation agent-related complications, and adjusting in real time, if needed, the anticoagulation regimen or therapy to maintain the subject's INR level within a desired range.

In summary, the present invention is directed to a method and system for point-of-dispensing, point-of-sale, or retail pharmacy management of an anticoagulation agent therapy, for real time evaluation and/or assessment of any complications affecting the anticoagulation therapy, and for immediate intervention, if needed, by or at the direction of a person or entity, other than the referring or prescribing physician, or other health care practitioner.

### BRIEF DESCRIPTION OF THE DRAWINGS

One of the above and other concepts, objects, novel features and advantages of the present invention will become apparent from the following detailed description of the preferred embodiment(s) invention, as illustrated in the drawings, in which:

FIGS. 1A-1C illustrate a flow chart of the overall method in accordance with an embodiment of the present invention;

FIGS. 2A-2C illustrate a flow chart for real time evaluation of a subject in accordance with an embodiment of the present invention;

FIG. 3 illustrates a flow chart for real time intervention in accordance with an embodiment of the present invention;

FIGS. 4A-4B illustrate a flow chart for employing bridge therapy for a subject in accordance with an embodiment of the present invention;

FIG. 5 illustrates a user interface display showing patient information;

FIG. 6 illustrates a user interface display showing patient summary;

FIG. 7 illustrates a user interface display showing anticoagulant dosage information and medical complications;

FIG. 8 illustrates a user interface display showing a particular complication for a patient;

FIG. 9 illustrates a user interface display showing a detailed visit report;

FIG. 10 illustrates a user interface display showing anticoagulant dosage and lab visit details;

FIG. 11 illustrates a user interface display showing anticoagulant as well as other medications being taken by a patient;

FIG. 12 illustrates a user interface display showing a patient snapshot report;

FIG. 13 illustrates a user interface display detailing recent chronological history of a patient;

FIG. 14 illustrates a user interface display showing warfarin and other medications being taken by a patient;

FIG. 15 illustrates a user interface display showing a prescription (non-warfarin) to an over-the-counter medication (Aspirin®) interaction;

FIG. 16 illustrates a user interface display showing a multiple vitamin (OTC) to a non-warfarin prescription interaction;

FIG. 17 illustrates a user interface display showing a multiple vitamin (OTC) to warfarin interaction;

FIG. 18 illustrates a user interface display showing Aspirin® (OTC) to warfarin interaction;

FIG. 19 illustrates a user interface display showing Tylenol® (acetaminophen—OTC) to warfarin interaction;

FIG. 20 illustrates a user interface display showing an antibiotic (Erythromycin®) to warfarin interaction;

FIG. 21 illustrates a user interface display showing an antibiotic (Ciprofloxacn®) to warfarin interaction;

FIG. 22 illustrates a user interface display showing a prescription drug (Ibuprofen®) to prescription drug (Metoprolol®—non-warfarin) interaction;

FIG. 23 illustrates a user interface display showing a prescription drug (Ibuprofen® to warfarin interaction;

FIG. 24 illustrates a user interface display showing disease indications for a drug (Lisinopril®);

FIG. 25 illustrates a user interface display showing a disease (diabetes) to drug (Lisinopril®) interaction; and

FIG. 26 illustrates a user interface display for selecting a particular strength warfarin.

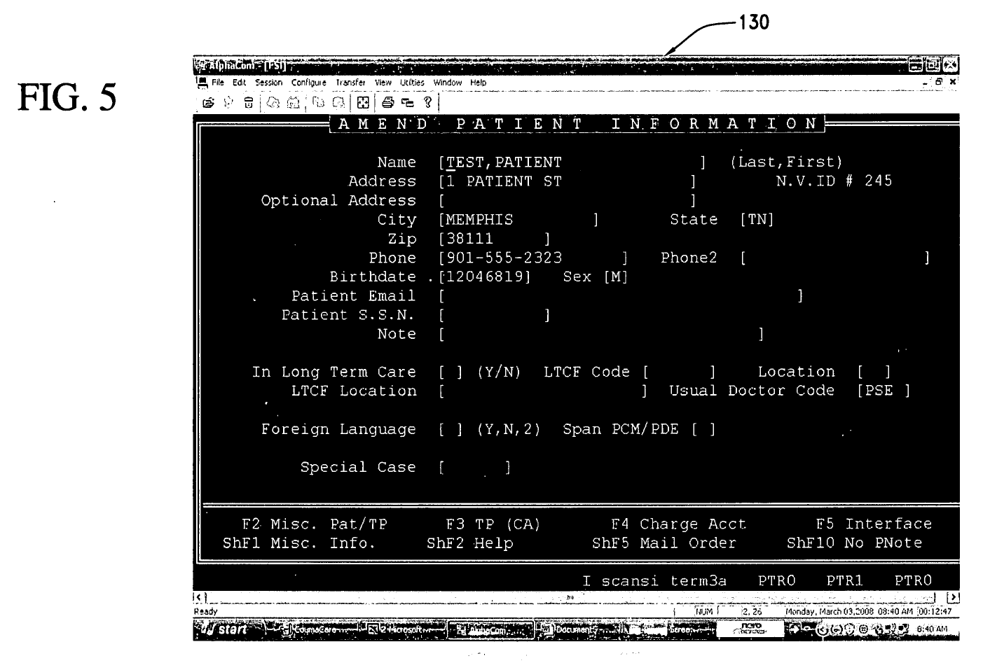

It is noted herewith that FIGS. 5-26 merely illustrate non-limiting examples of various user interface displays or screens generated by a system used in the present invention, depicting information, which would vary depending on the patient, diagnosis, medical history, and situation, etc.

### DETAILED DESCRIPTION OF THE PREFERRED EMBODIMENT(S) OF THE INVENTION

The present invention has been devised to assist health care practitioners in the management of anticoagulation agent therapy for their patients. Although most commonly used anticoagulation agents, include warfarin (Coumadin® ) and enoxaparin (Lovenox®), other anticoagulants may also be employed, which include heparin, low-molecular weight heparin, such as dalteparin (Fragmin®), fondaparinux (Arixtra®), Factor Xa inhibitors, antiplatelet drugs, such as clopidogrel (Plavix®) and Aspirin®.

Under the present invention, the entire anticoagulation agent management and therapy takes place at a location other than a health care facility, such as a hospital or practitioner's office, once a diagnosis is made and the health care practitioner prescribes anticoagulation therapy. In particular, the anticoagulation agent therapy is preferably managed by a point-of-dispensing or point-of-sale facility, such as a pharmacy, drug store, or the like retail establishment, where a pharmacist manages and runs the anticoagulation therapy-related services, once a patient has been referred by a health care practitioner.

Typically, a patient would have the symptoms and/or diagnosis of a disease process that requires either short-term or chronic anticoagulation agent therapy. Non-limiting examples of these conditions include: atrial fibrillation (AF), cerebrovascular accident (CVA), transient ischemic attack (TIA), heart valve repair or replacement, including cadaver, porcine, or porcelin valves, deep vein thrombosis (DVT), pulmonary embolism (PE), post-surgery status, where patient is immobile, such as hip and/or knee arthroplasty and pelvic fractures, and Protein C and S deficiency.

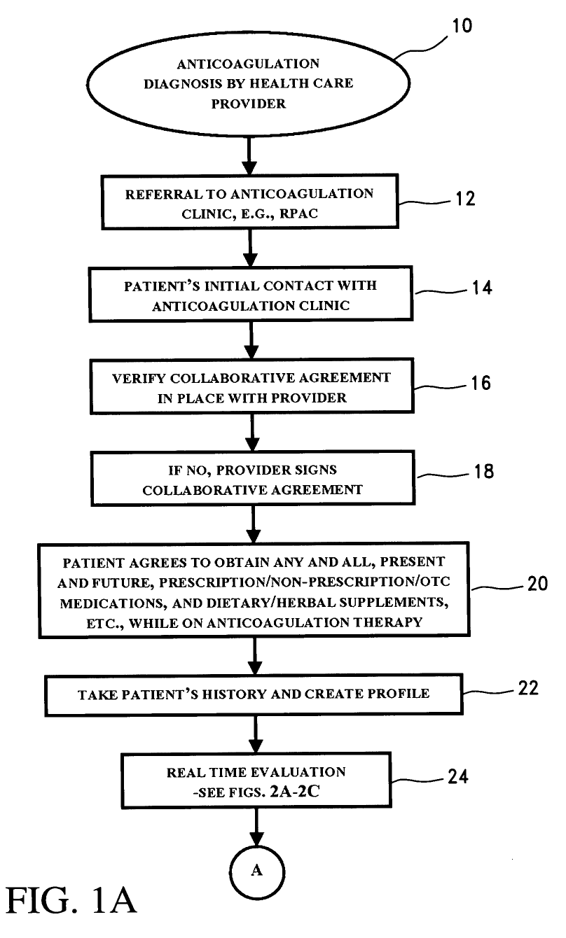

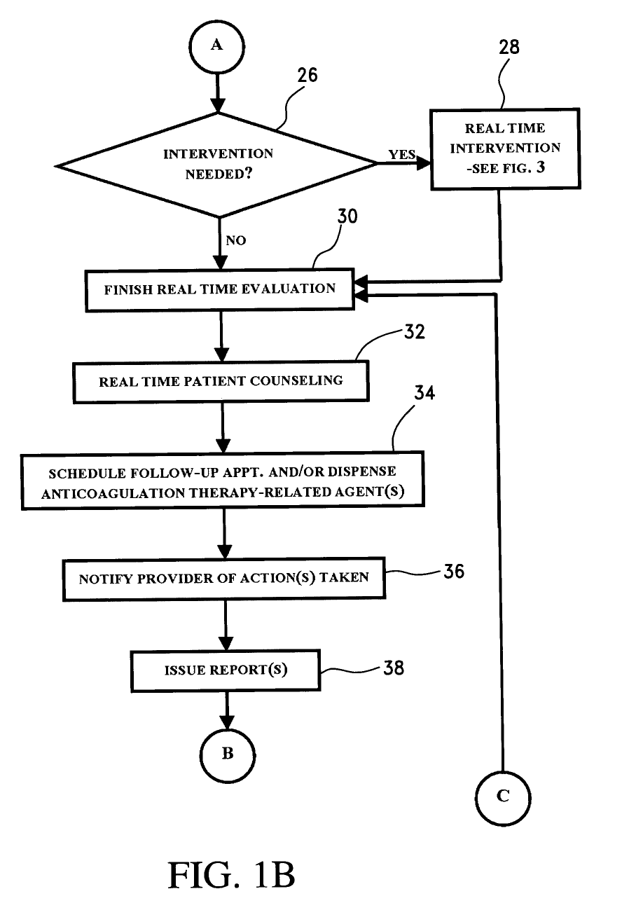

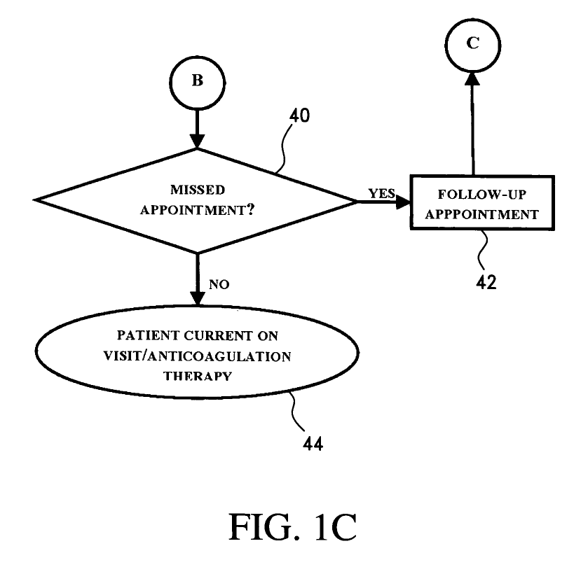

Referring to flow charts illustrated in FIGS. 1A-1C, an embodiment of the overall method of the present invention will now be described. Once a physician or other health care provider makes an appropriate diagnosis that would require the patient to follow an anticoagulation therapy (step 10), the patient is referred to an anticoagulation clinic (step 12), such as a retail pharmacy anticoagulation clinic (RPAC) having a pharmacist to manage and run the anticoagulation therapy. The pharmacist is preferably specially-trained in anticoagulation therapy and related matters.

Upon the patient making the initial contact with the anticoagulation clinic (step 14), the pharmacy or the clinic verifies the existence of a collaborative agreement with the health care provider (step 16). The existence of a collaborative agreement, whether previously executed or subsequently obtained, defines the role of the clinic/pharmacist, allowing them to manage, including prescribing, adjusting dosage, and/or monitoring, the anticoagulation agent regimen for the patient, without direct health care provider's involvement. The agreement would be in compliance with Federal, State and other applicable laws and regulations. An example of such collaborative agreement and associated forms, used by the inventors in Utah, are attached herewith as references, and are hereby incorporated herein in their entirety by reference.

If there is no prior collaborative agreement in place, the provider executes one prior to proceeding with the anticoagulation therapy (step 18). Once the agreement is in place, the patient is counseled to follow the clinic's requirements, one of which is to obtain any and all, present and future, prescription/non-prescription/over-the-counter (OTC) medications, dietary supplements, herbal medications, herbal supplements, vitamins, minerals, and any other food items that may effect or interfere with the anticoagulation therapy, at least during the period the patient is on the anticoagulation therapy (step 20). Appropriate history of the patient is then taken to create a profile which is maintained in a database for tracking and monitoring purposes (step 22).

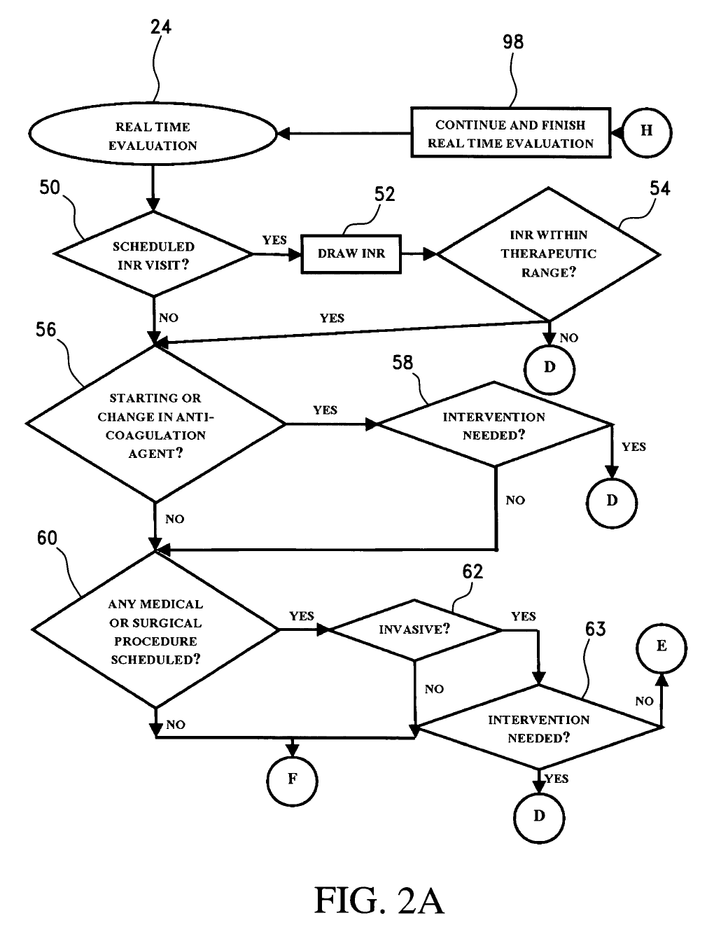

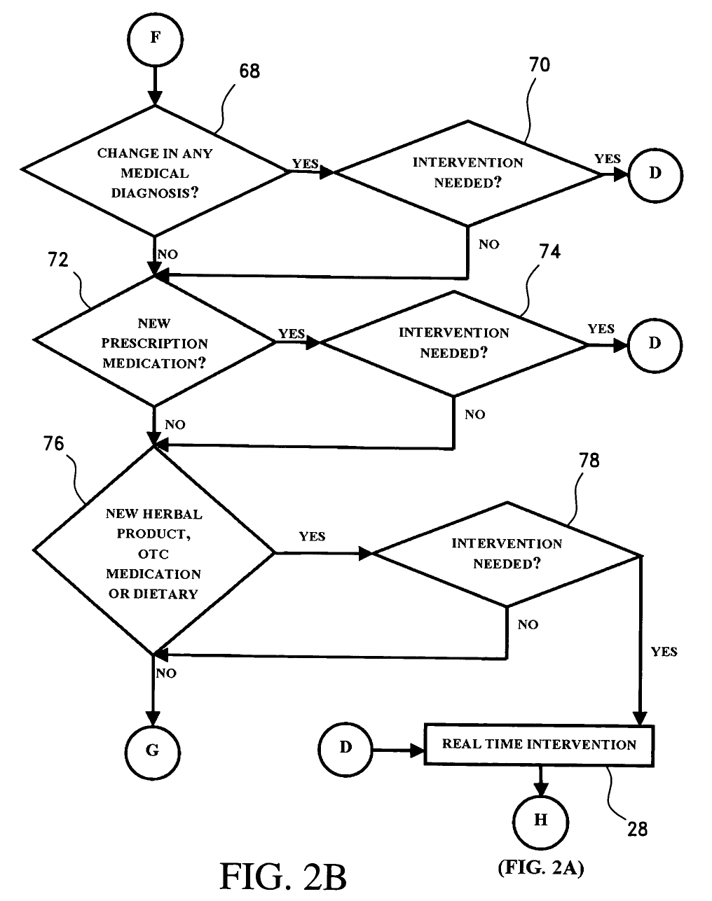

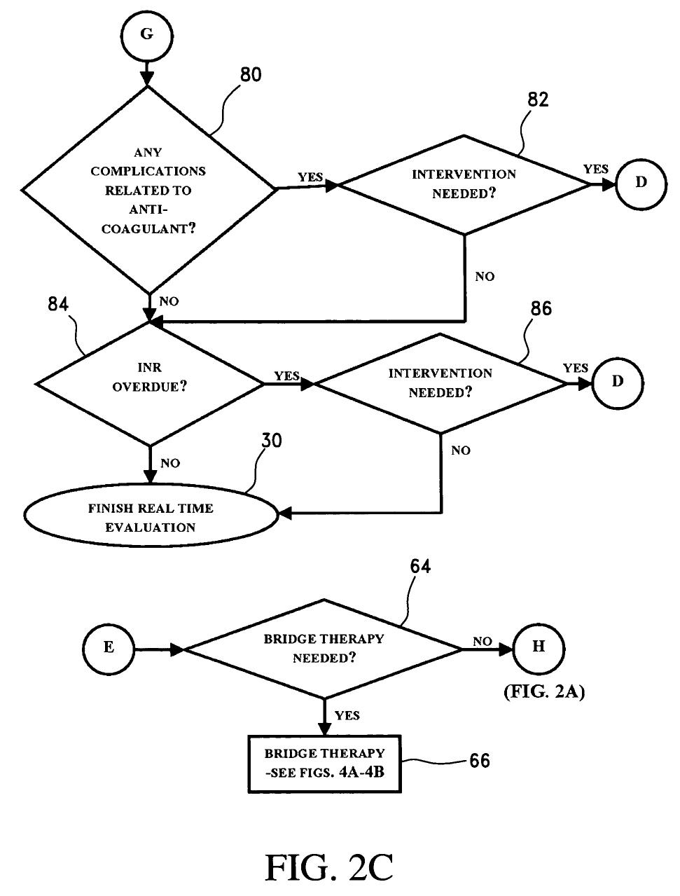

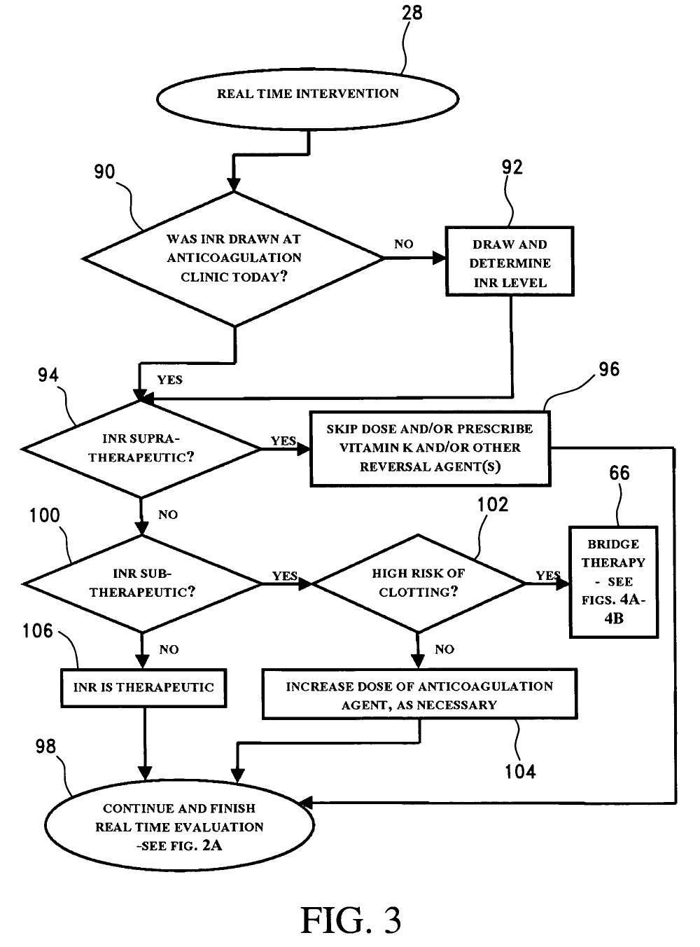

A real time evaluation of the patient (FIGS. 2A-2C) then begins (step 24), during which it is determined whether or not an immediate or real time intervention is needed (step 26). If yes (step 28), a real time intervention procedure (FIG. 3) is followed. If no intervention is needed, or upon completion of real time intervention, the real time evaluation is finished (step 30), and the patient is then educated and counseled (step 32) on the therapy process and safe and effective use of anticoagulation agent. If necessary, a follow-up appointment is scheduled and, if appropriate, anticoagulation therapy-related agents are dispensed (step 34). The health care provider is then notified of the actions taken at the clinic in accordance with the collaborative agreement (step 36) and, if appropriate, one or more reports are issued (step 38).

If the patient misses the scheduled appointment (step 40), another follow-up appointment is made (step 42) to finish the real time evaluation. If the patient is current on his/her visits, the system is updated to indicate that the anticoagulation therapy is on schedule (step 44).

### Real Time Evaluation

Referring to FIGS. 2A-2C, the real time evaluation process will now be described in more detail. If this is a follow-up visit scheduled previously (step 50), the patient's blood is drawn (step 52) to determine the current INR level (step 54). If the level is not within the therapeutic range, i.e., is above or below the desired range, real time intervention procedure is followed in the patient's anticoagulation therapy (step 28 in FIG. 2B, and FIG. 3).

If the INR level is within the therapeutic or desired range, the patient is questioned as to whether he/she is starting on an anticoagulation agent or if there has been any change in anticoagulation agent regimen (step 56). If the answer is in the affirmative to either of these questions, the pharmacist determines the need for an immediate or real time intervention (step 58). Preferably, this is based on the pharmacist's observation and evaluation of the patient for any signs and/or symptoms of any anticipated anticoagulation therapy/agent-related complications. If the pharmacist believes that an intervention is necessary, the real time intervention procedure (FIG. 3) is followed. If not, the patient is further inquired whether any medical or surgical procedure is forthcoming or scheduled (step 60) and, if yes, whether it is invasive (step 62). Due to various complications that may arise in an invasive procedure or surgery, the pharmacist again determines whether intervention is needed (step 63). If yes, the real time intervention procedure (FIG. 3) is followed.

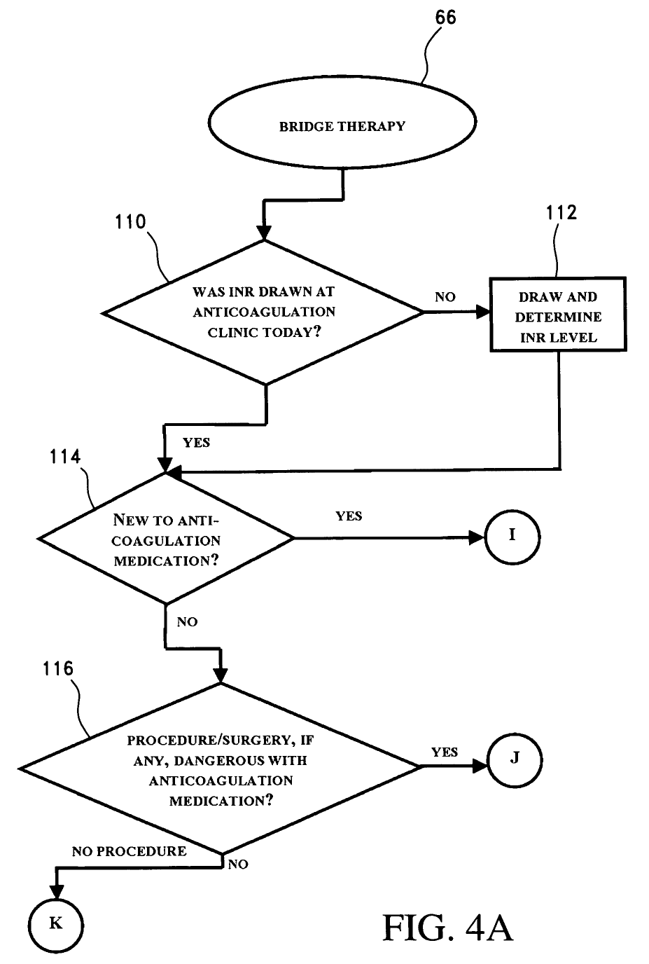

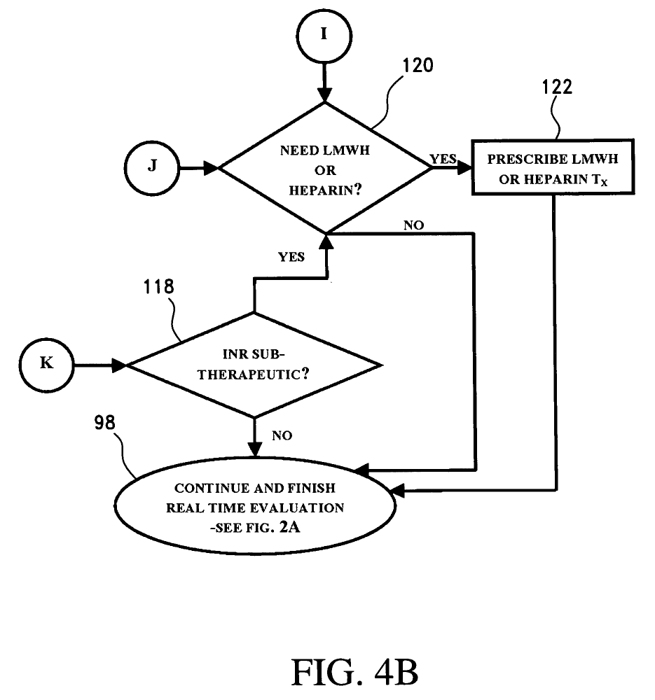

If it is determined that real time intervention is not needed, the pharmacist then determines the need for bridge therapy (step 64 in FIG. 2C). If yes, the bridge therapy procedure, outlined in FIGS. 4A-4B, is followed (step 66). If no bridge therapy is needed, the patient is further continued on to finish the real time evaluation procedure (step 98 in FIG. 2A).

In particular, it is further inquired whether there has been any change in any medical problems, diagnosis or recent illness (step 68) that might affect the anticoagulation therapy. Based on the patient's responses, a determination for an intervention is again made (step 70) and real time intervention procedure is followed. If no intervention at this point is needed, the patient is then inquired as to any new prescription medication that he/she may have been prescribed (step 72) that might interfere or react with the anticoagulation agent therapy requiring intervention (step 74).

If there is no new prescription medication, then the patient is further inquired if he/she is planning on taking any non-prescription medication or agents, such as any over-the-counter medications, herbal products, or other food or dietary supplements (step 76). If yes, the pharmacist again determines any adverse effects of these agents on the anticoagulation therapy that might require intervention (step 78). If no intervention is deemed necessary at this point, the patient is inquired as to any complications relating to any anticoagulation agent that the patient may have been taking, or the therapy itself (step 80). This evaluation of patient by the pharmacist includes observing for and inquiring for signs and/or symptoms of adverse effects, including bruising, bleeding gums, nose bleeds, blood in the urine or stool, chest pain, difficulty in breathing, headaches, shortness of breath, and swelling of the legs.

Based on any signs and/or symptoms of anticoagulation-related complications, the pharmacist again determines the need for intervention (step 82). If no intervention is needed, it is determined whether INR testing is due or should be done (step 84).

If based on the patient history and profile, and the responses received during the current visit and the pharmacist's visual observation and evaluation of the patient, it is determined that there is no need to do another INR, the real time evaluation is finished (step 30 in FIG. 1B) and the usual patient counseling is continued (step 32). Otherwise, it is again determined whether or not real time intervention is needed (step 86). If not, the patient is finished with the real time evaluation (step 30 in FIG. 1B).

### Real Time Intervention

Referring to FIG. 3, the procedure for following real time intervention will now be described. It is first determined whether INR was drawn during the patient's current visit (step 90). If not, the patient's blood is drawn to determine the current INR level (step 92). If the INR level is determined to be supra-therapeutic, i.e., higher than normal or above the desired range (step 94), the pharmacist recommends to skip the previously scheduled dose of the anticoagulation agent, prescribes Vitamin K or other reversal agents for anticoagulation agent therapy reversal, or a combination thereof, as appropriate (step 96). The patient is then continued on to finish the real time evaluation (step 98, and step 30 in FIG. 1B).

If, on the other hand, the INR level is sub-therapeutic (step 100), it is determined whether there is a high risk of clotting (step 102). If a high risk of clotting is present, the procedure for bridge therapy (FIGS. 4A-4B) is followed. If there is no risk of clotting, the pharmacist increases the dose of the anticoagulation agent, as necessary (step 104).

If the INR level is determined to be therapeutic, or within the desired range (step 106), the patient is continued on to finish the real time evaluation, as before.

Referring to FIGS. 4A-4B, the procedure for bridge therapy will now be described. As noted previously, when using an anticoagulant agent, such as warfarin, a bridging medication is generally required. This is because the anticoagulant agents typically have a delayed onset and effect, thereby necessitating the need for one or more other agents to cover the delay in action, when the anticoagulation agent is started or when it is held, in cases of medical, surgical, dental or other medical intervention.

Once it is determined that the bridge therapy procedure should be followed, it is confirmed whether or not an INR was drawn at the anticoagulation clinic during the patient's visit today (step 110). If not, the patient's blood is drawn to determine current INR level (step 112). Next, it is determined whether the patient is new to anticoagulation medication (step 114). If the patient is not new to anticoagulation medication, it is determined whether any procedure or surgery that the patient may soon be undergoing, is in conflict with or dangerous to the anticoagulation agent (step 116). If there is no procedure or surgery scheduled, it is determined if the current INR level is sub-therapeutic (step 118) and, if not, the patient is continued on to finish the real time evaluation (step 98 in FIG. 2A).

If the patient is new to anticoagulation medication, the pharmacist determines the need to prescribe heparin or low-molecular weight heparin (step 120) and prescribes the same, as necessary (step 122). The pharmacist also determines the need to prescribe heparin or low-molecular weight heparin (step 120), if the patient will be undergoing a procedure or surgery (step 116), and prescribes the same, as necessary (step 122). The patient is then continued on to finish the real time evaluation (step 98 in FIG. 2A).

FIGS. 5-28 illustrate various user interface displays or computer screens generated by a system used in conjunction with the method of the present invention. The system is preferably a personal computer type database system compatible with the Internet and having various capabilities to receive, store, and manage patient information and cross-check drug-drug, drug-disease, drug-food, drug-food or dietary supplement, drug-allergy, drug-age, drug-gender, etc., interactions and complications. The system also has the capability to track all of the patient's prescription-related information and activities. One such system, illustrated herein, is known as CoumaCare®, available from the Bristol-Myers Squibb Company.

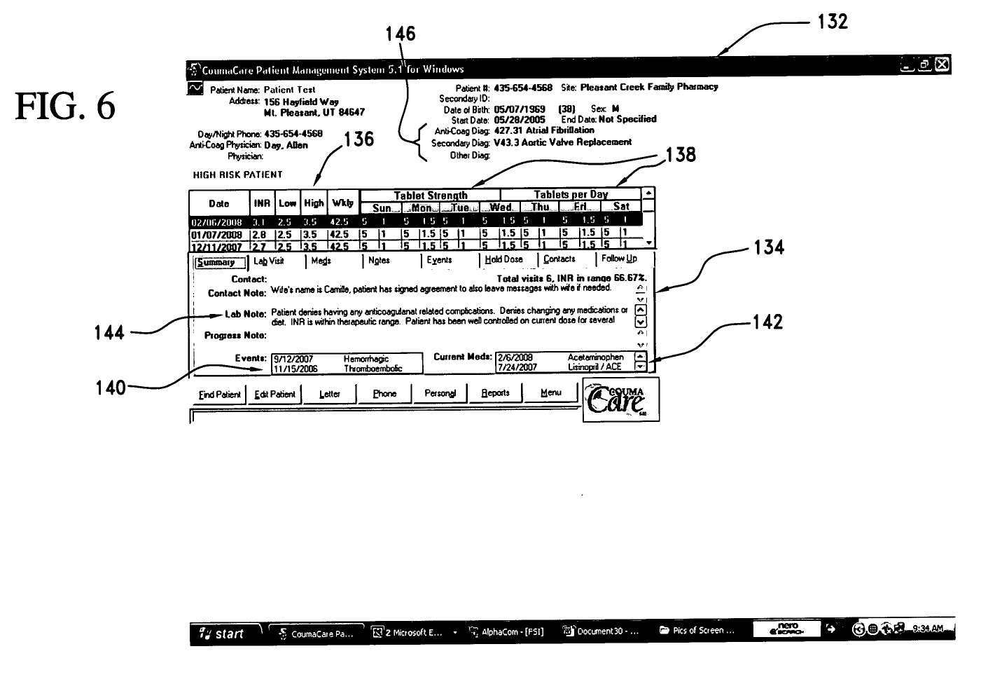

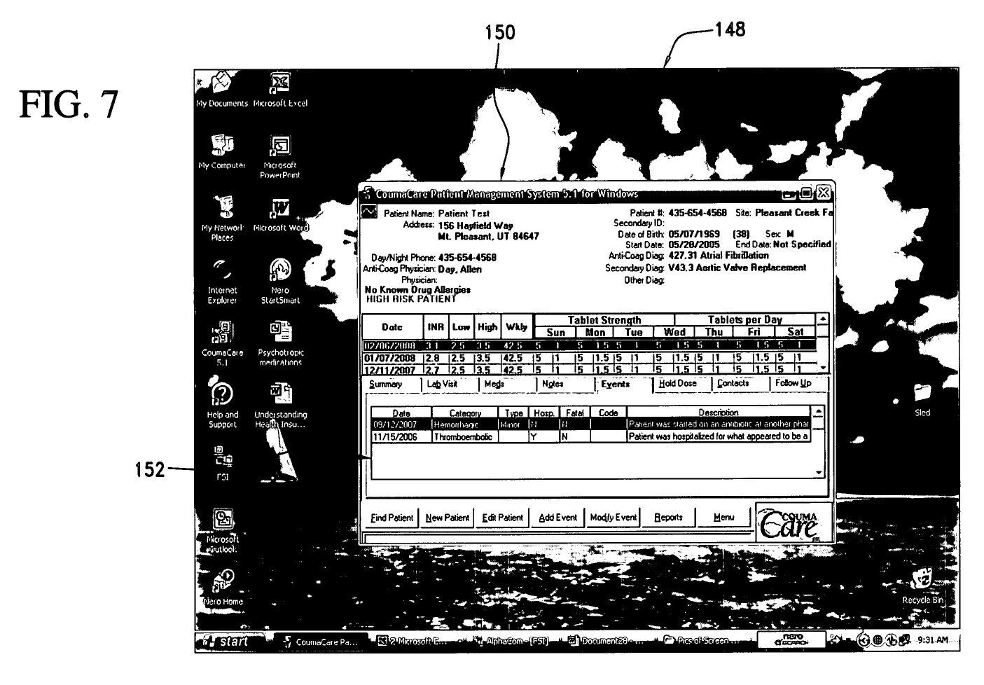

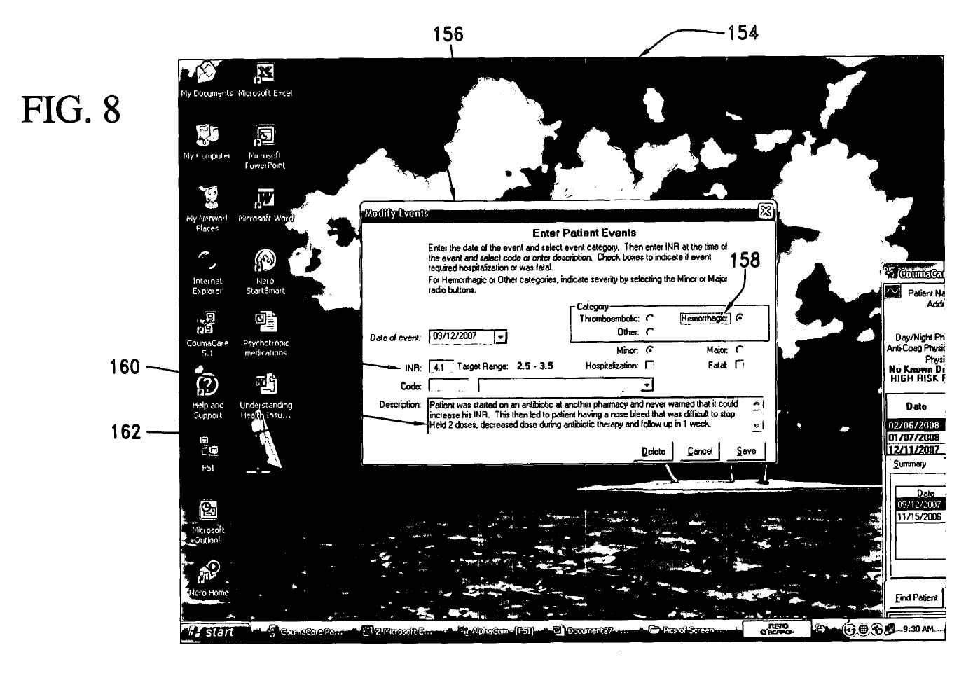

As illustrated, FIGS. 5-8 show patient-related data screens. In particular, FIG. 5 illustrates a screen 130, showing the personal information of a patient. FIG. 6 illustrates a screen 132, showing summary information for a patient. In particular, the screen 132 displays a window 134 with various INR levels 136, the anticoagulant dosage information 138, past complications 140, other medications that the patient is currently taking (numeral 142), and patient consultation notes 144. The window 132 also displays patient diagnosis 146 for the anticoagulant therapy. FIG. 7 illustrates a screen 148 with a window 150 (similar to FIG. 6), wherein an events window 152 provides details of past complications. FIG. 8 illustrates a screen 154 with a window 156, detailing a minor hemorrhagic event 158. The window 156 shows the patient's INR level 160 to be supra-therapeutic, which led to an intervention 162, withholding two doses and decreasing the dose during antibiotic therapy with a follow-up.

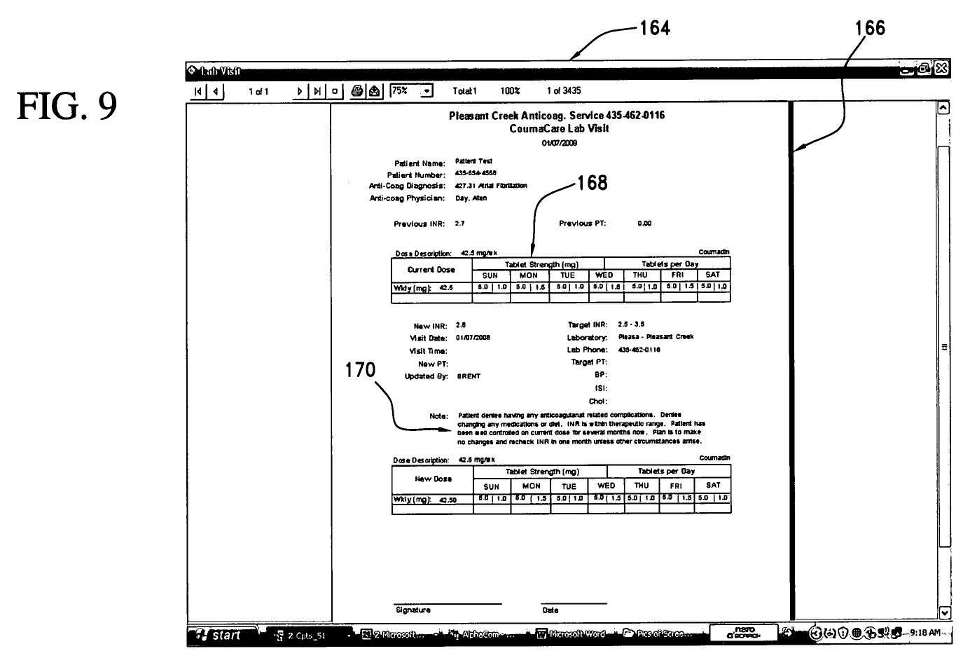

FIG. 9 illustrates a screen 164, showing a detailed lab report 166 with current Coumadin® dosage information 168 and patient consultation notes 170.

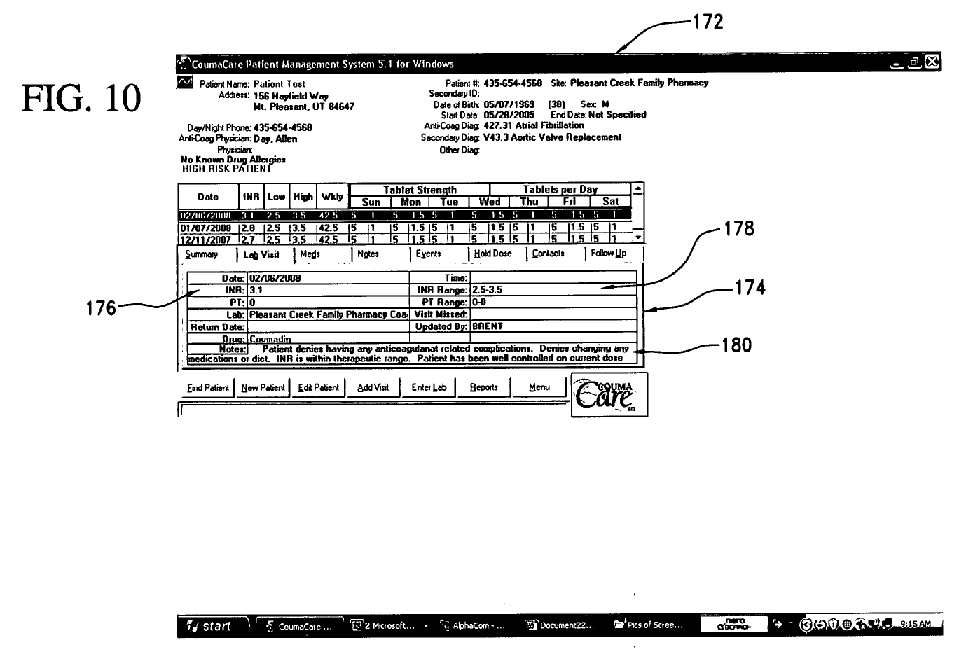

FIG. 10 illustrates a screen 172, showing a lab visit summary window 174, similar to FIGS. 6-7, and including the current INR level 176, the desired INR range 178, and patient consultation notes 180.

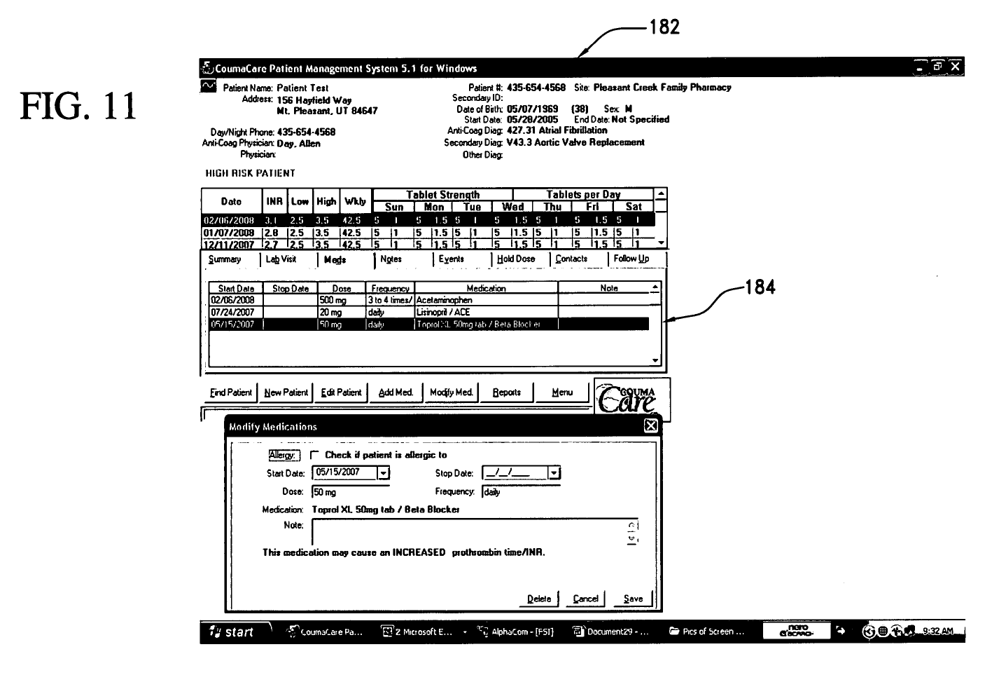

FIG. 11 illustrates a screen 182, showing a summary window 184, detailing various medications that the patient is taking.

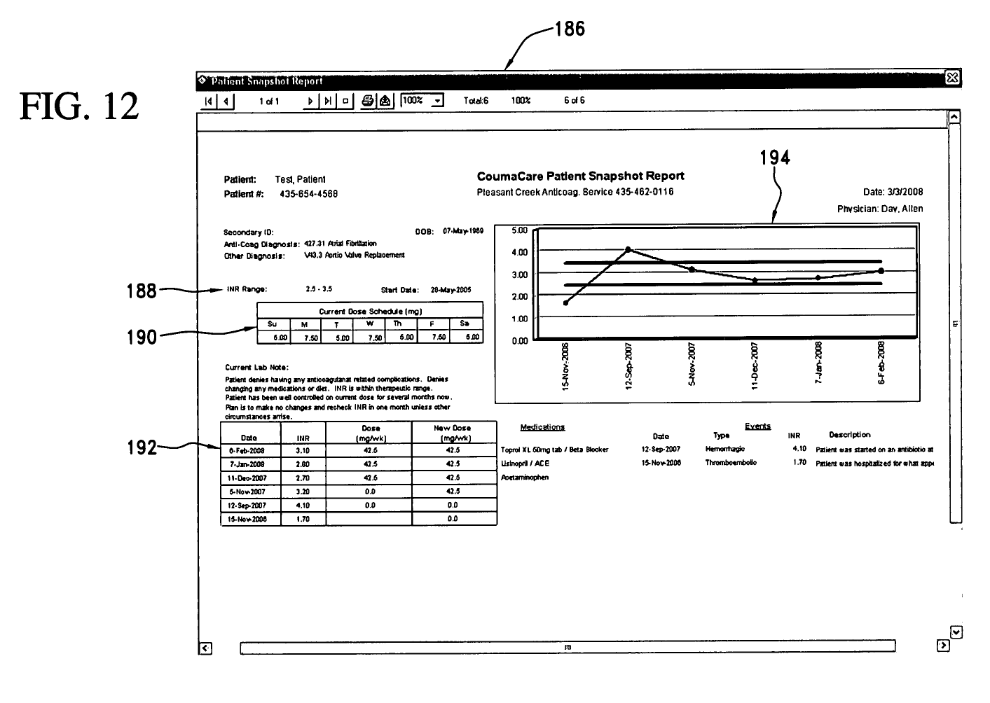

FIG. 12 illustrates a screen 186, showing a patient snapshot report, including the desired INR range 188, current dosage schedule 190, a table 192 of various INR levels, current and new dosage, and a graph 194 corresponding to various INR levels.

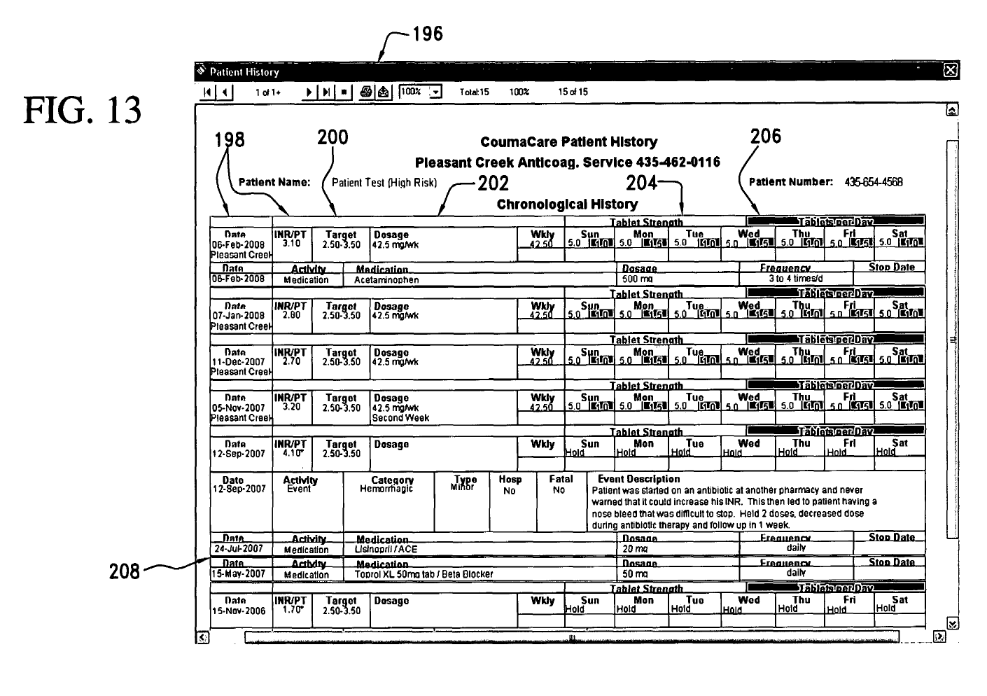

FIG. 13 illustrates a screen 196, showing chronological history for the patient. The history includes the actual INR level 198 on a particular date, the target INR level 200, the weekly anticoagulation agent dosage 202, tablet strength 204, daily dosage 206 and other medication information 208.

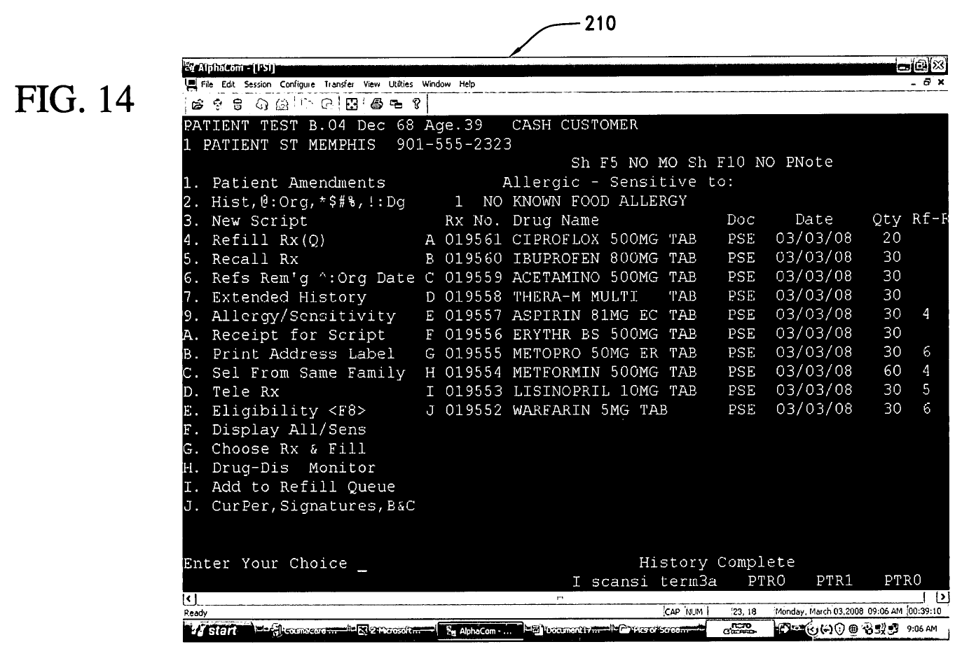

FIG. 14 illustrates a patient summary and history screen 210, detailing various prescriptions, including warfarin prescription, filled for a patient.

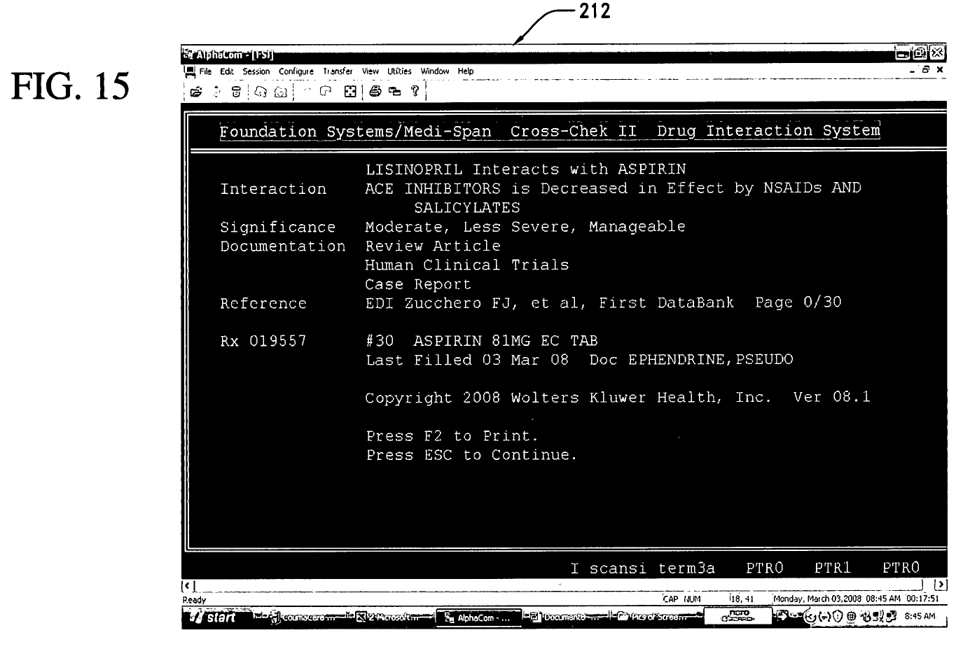

FIG. 15 illustrates a screen 212, indicating interaction of a non-warfarin prescription drug, Lisinopril®, with an over-the-counter medication, Aspirin®.

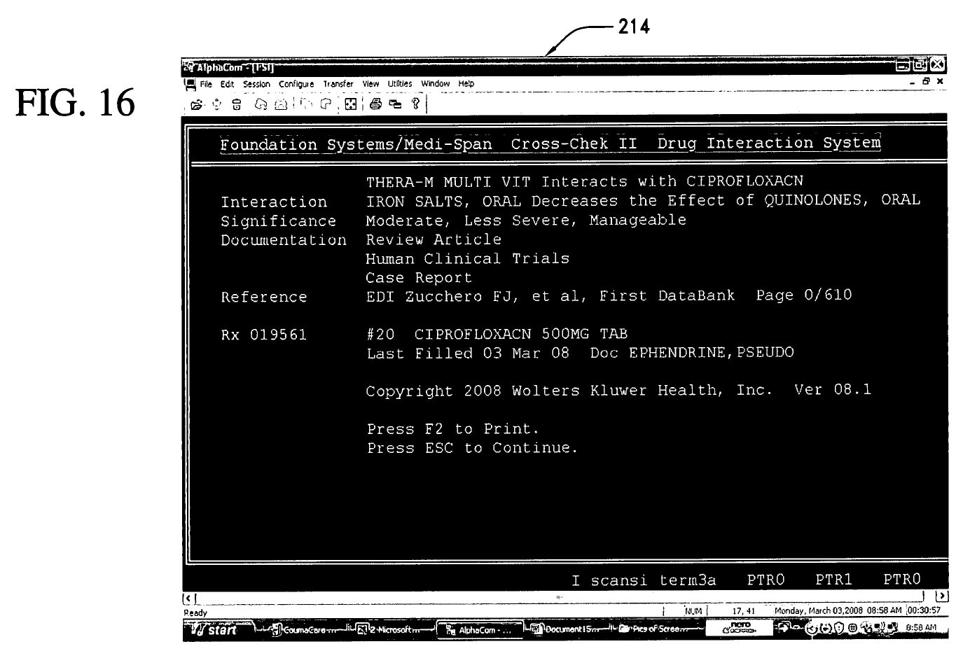

FIG. 16 illustrates a screen 214, indicating interaction of a multi-vitamin, Thera-M®, with a non-warfarin prescription drug, Ciprofloxacn®.

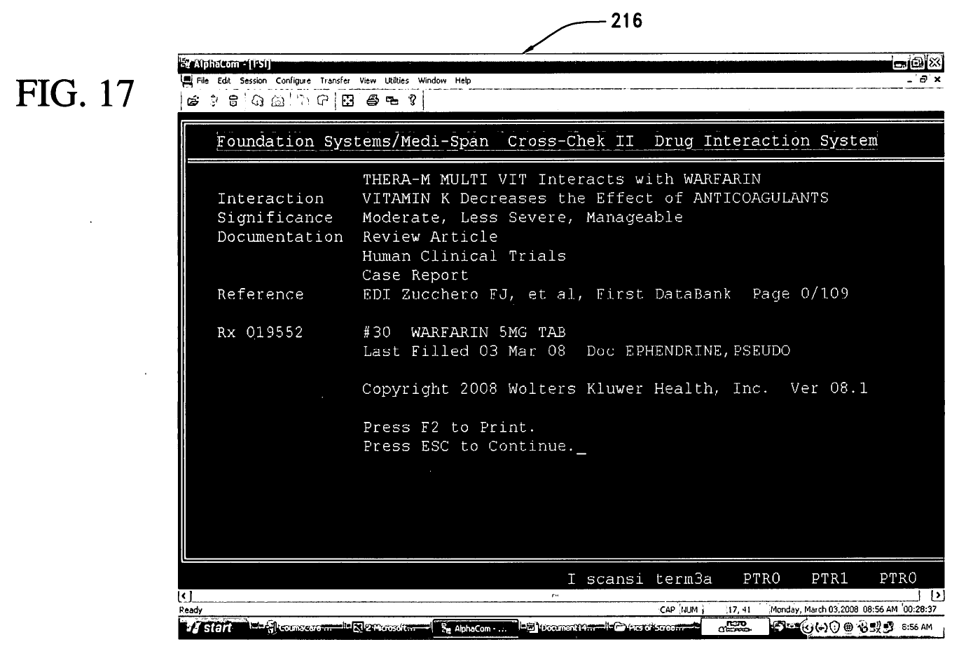

FIG. 17 illustrates a screen 216, indicating interaction of a multi-vitamin, Thera-M®, with warfarin.

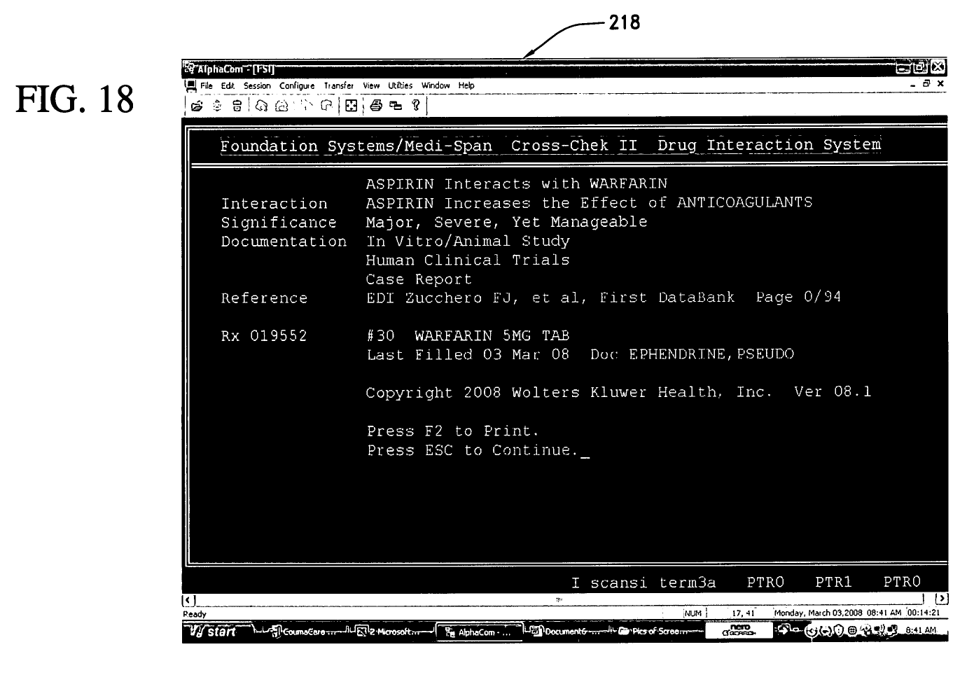

FIG. 18 illustrates a screen 218, indicating interaction of an over-the-counter drug, Aspirin®, with warfarin.

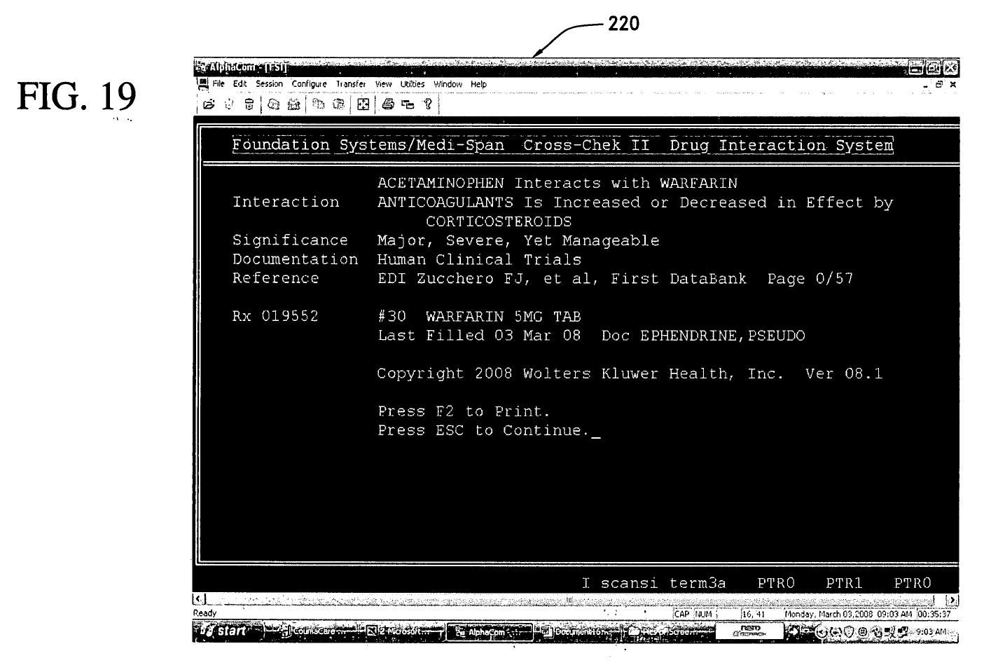

FIG. 19 illustrates a screen 220, indicating interaction of an over-the-counter drug, Tylenol® (acetaminophen), with warfarin.

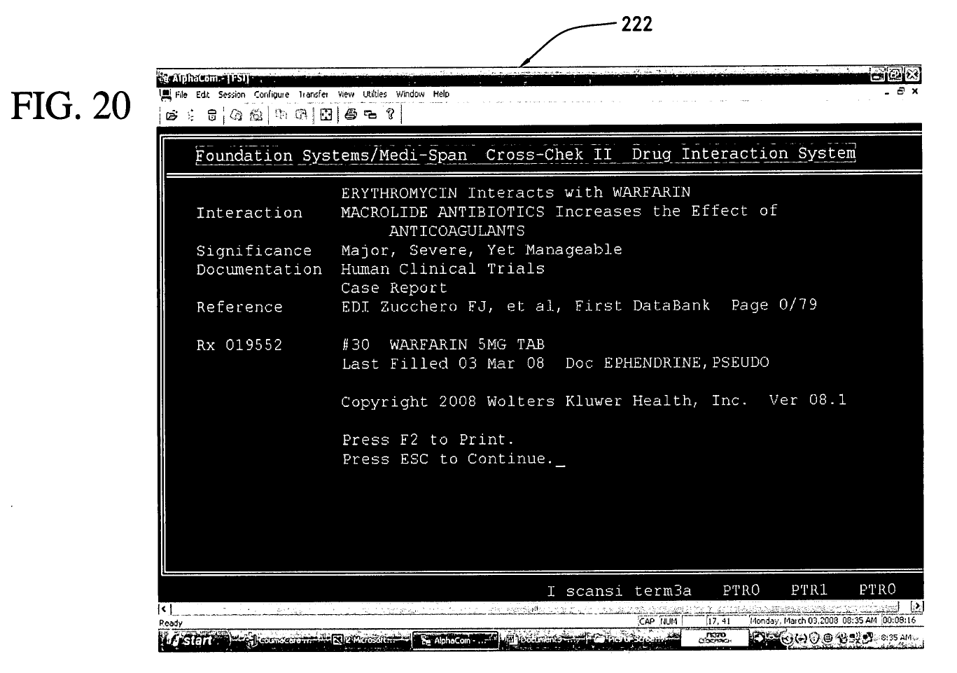

FIG. 20 illustrates a screen 222, indicating interaction of an antibiotic, Erythromycin®, with warfarin.

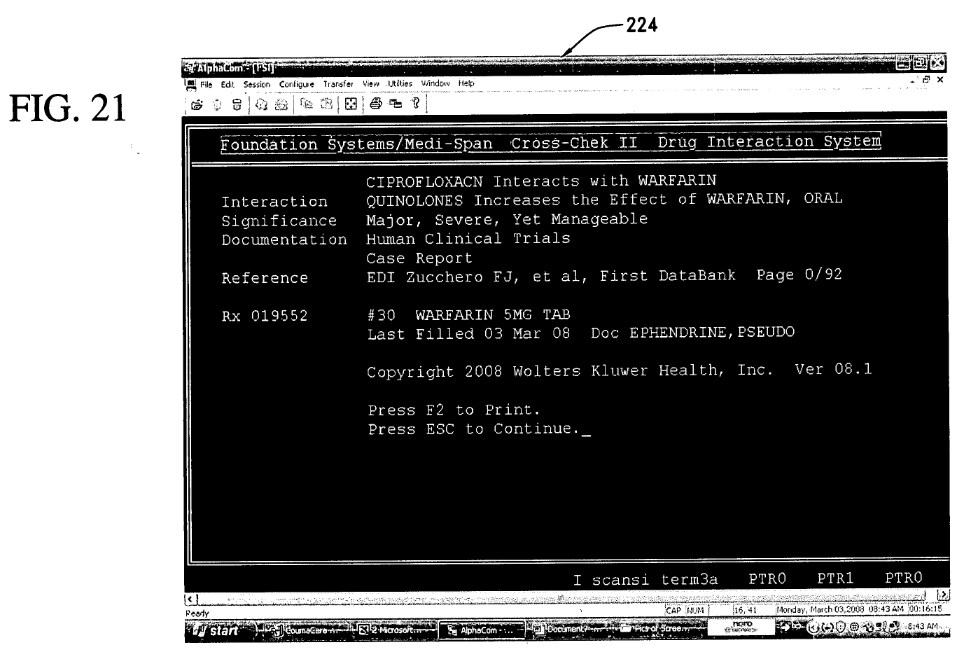

FIG. 21 illustrates a screen 224, indicating interaction of an antibiotic, Ciprofloxacn®, with warfarin.

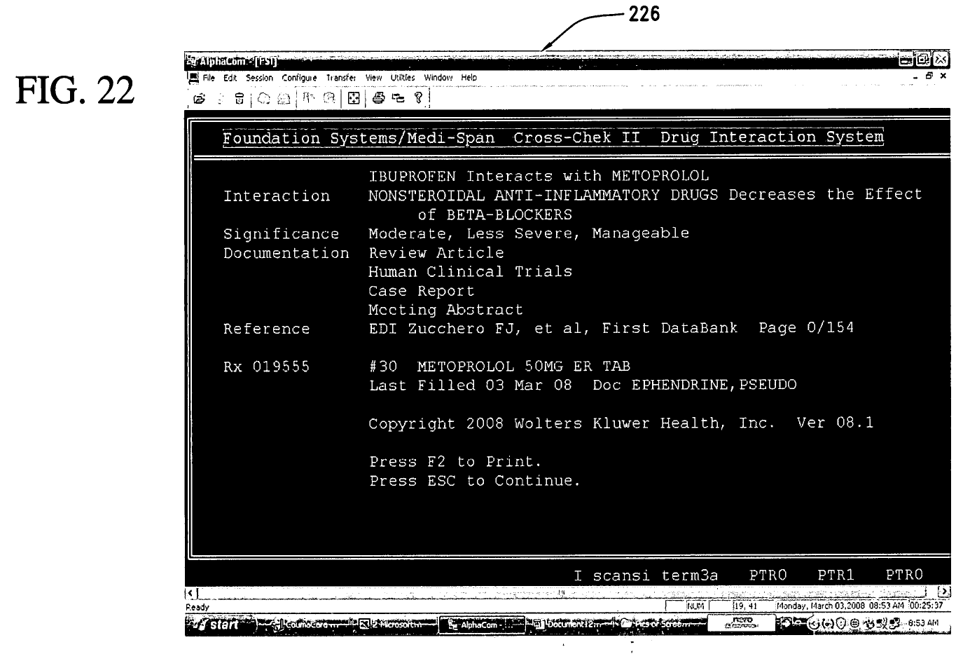

FIG. 22 illustrates a screen 226, indicating interaction of a prescription drug, Ibuprofen®, with a non-warfarin prescription drug, i.e., Metoprolol®.

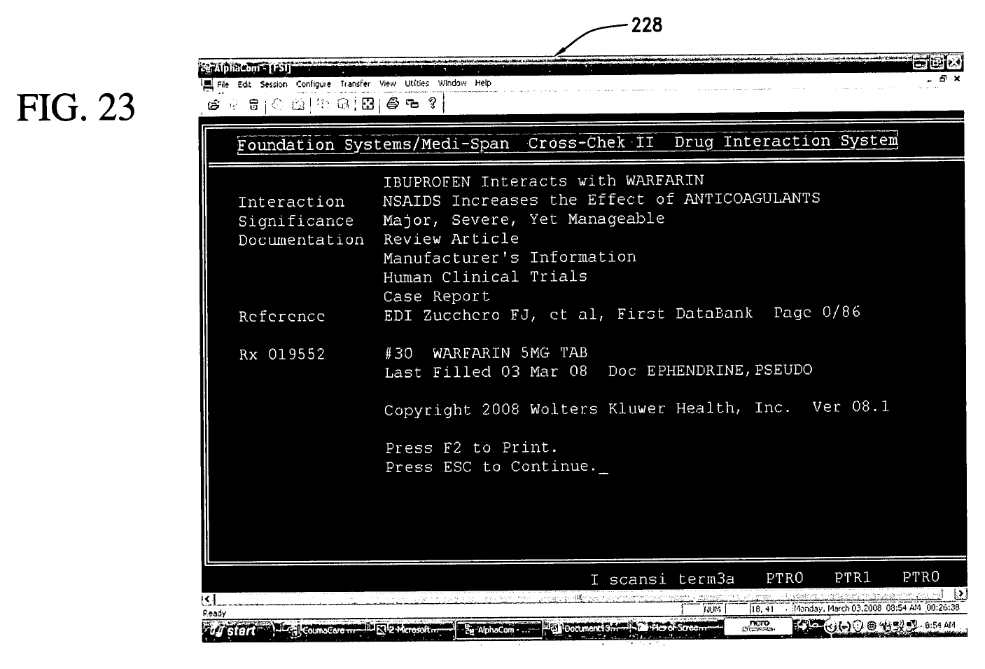

FIG. 23 illustrates a screen 228, indicating interaction of a prescription drug, Ibuprofen®, with warfarin.

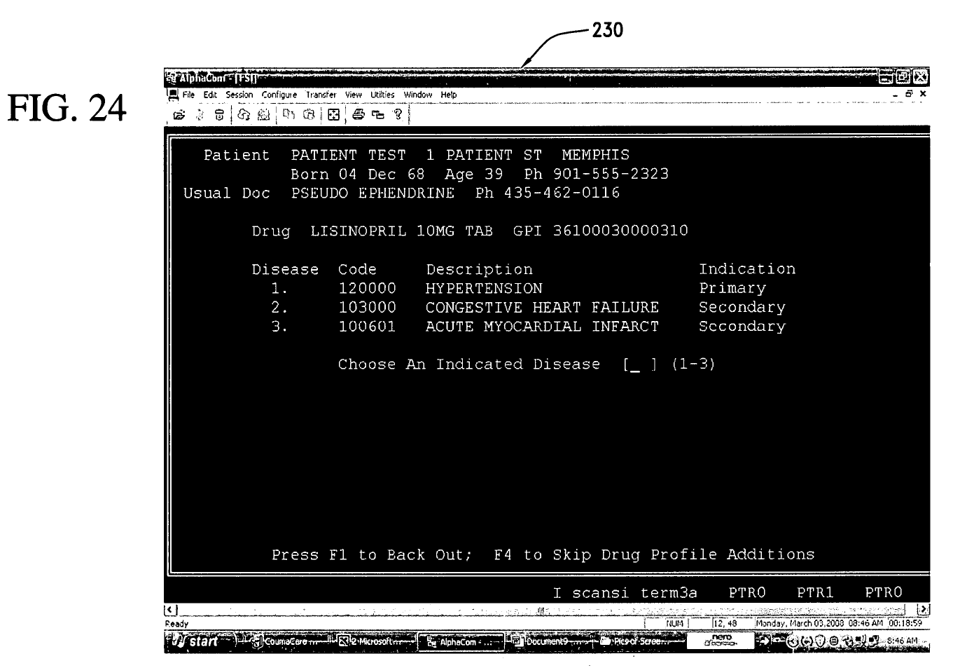

FIG. 24 illustrates a screen 230, indicating disease indications for a drug, Lisinopril®.

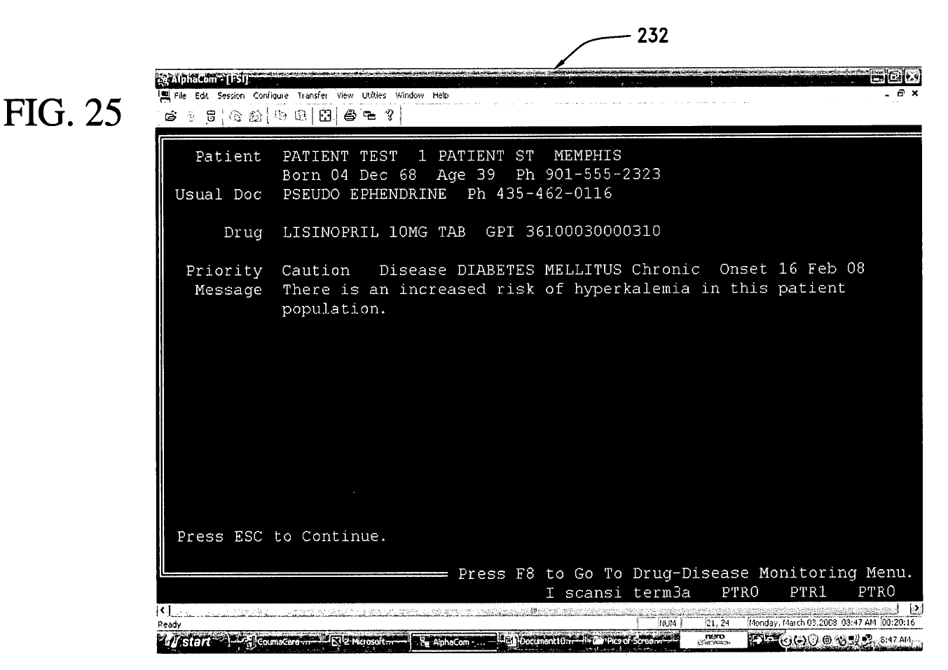

FIG. 25 illustrates a screen 232, indicating interaction of a drug, Lisinopril®, with diabetes.

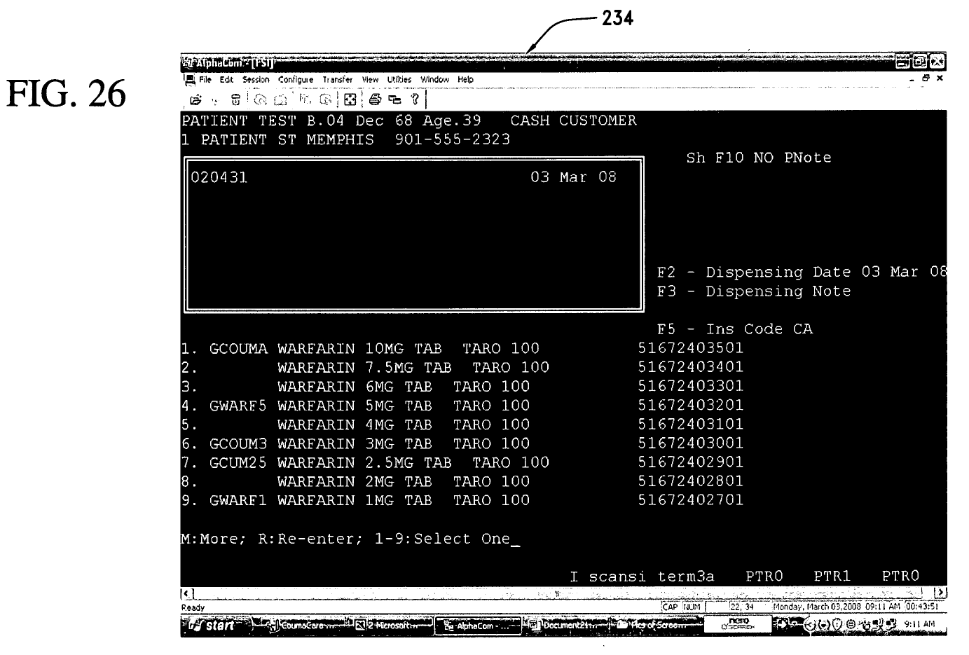

FIG. 26 illustrates a screen 234, indicating various strengths of warfarin for selection when filling a prescription.

It is noted herewith that while the invention has been described in terms of a pharmacist himself/herself participating in the process, it is within the scope of the invention to initiate and/or complete the process, or any part thereof, at the direction and/or supervision of the pharmacist.

While this invention has been described as having preferred sequences, ranges, steps, materials, structures, features, components, or designs, it is understood that it is capable of further modifications, uses and/or adaptations of the invention following in general the principle of the invention, and including such departures from the present disclosure as those come within the known or customary practice in the art to which the invention pertains, and as may be applied to the central features hereinbefore set forth, and fall within the scope of the invention and of the limits of the appended claims.

### REFERENCES

The following references, and those cited in the disclosure herein, are hereby incorporated herein in their entirety by reference.
1. Pleasant Creek Family Pharmacy, “Pleasant Creek Family Pharmacy—Anticoagulation Service Protocol.” 4 pages (January 2007).
2. Pleasant Creek Family Pharmacy Forms, “Anticoagulation Clinic: Patient History.” 1 page (January 2007); “Coumadin Dosing Form.” 1 page (January 2007); “Anticoagulation Management Request Form.” 1 page (January 2007).

What is claimed is:

1. A method for point-of-dispensing management of an anticoagulation agent therapy for a subject, comprising the steps of:
a) reviewing an anticoagulation regimen and obtaining data for a subject relating to anticoagulation therapy;
b) determining an International Normalized Ratio (INR) level for the subject;
c) determining any potential interaction of the anticoagulation agent with one or more non-anticoagulation agents that the subject intends to take or is taking;
d) evaluating in real time any need to adjust the anticoagulation regimen based on a determination made in one or both steps b) and c); and
e) adjusting in real time, if needed, the anticoagulation regimen to maintain the subject's INR level within a desired range.

2. The method of claim 1, wherein:
the step a) of obtaining data comprises compiling a list of one or more non-anticoagulation agents that the subject intends to take or is taking.

3. The method of claim 2, wherein:
the step a) of obtaining data further comprises assessing one or more of the following:
i) sign or symptom of hemorrhage, bleeding, and/or bruising;
ii) sign or symptom of thromboembolism;
iii) change in a condition requiring anticoagulation therapy;
iv) alteration in diet, medication, and/or alcohol intake;
v) recent alteration in a medical condition or illness;
vi) any complication relating to the anticoagulation agent; and
vii) compliance with anticoagulation therapy.

4. The method of claim 2, wherein:
the non-anticoagulation agent comprises at least one member selected from the group consisting of prescription medication, over-the-counter (OTC) medication, dietary supplement, herbal medication, herbal supplement, vitamin, mineral, food item, and a combination thereof.

5. The method of claim 1, further comprising the step of:
f) obtaining from, or on behalf of, the subject an assent to acquire any and all one or more non-anticoagulation agents that the subject intends to take or is taking.

6. The method of claim 4, wherein:
the step b) of determining an INR level comprises conducting a blood test to determine whether the INR level is sub-therapeutic, therapeutic, or supra-therapeutic.

7. The method of claim 6, wherein:
the step e) of adjusting the anticoagulation regimen comprises providing a supplemental anticoagulation agent, if the INR level is sub-therapeutic.

8. The method of claim 6, wherein:
the step e) of adjusting the anticoagulation regimen comprises reversing anticoagulation therapy, if the INR level is supra-therapeutic.

9. The method of claim 1, wherein:
at least one of steps d) and e) is performed by or at the direction of a person or entity other than the prescribing health care practitioner.

10. The method of claim 9, wherein:
the person or entity is a pharmacist or pharmacy.

11. The method of claim 10, wherein:
the step e) is performed by or at the direction of the pharmacist.

12. In a point-of-sale establishment, a method of managing an anticoagulation agent therapy for a subject, comprising the steps of:
a) reviewing an anticoagulation regimen prescribed by a health care practitioner for a subject;
b) enrolling the subject into an anticoagulation therapy program, the program including dispensing of an anticoagulation agent, as well as one or more non-anticoagulation agents that the subject intends to take or is taking;
c) assessing any sign or symptom of anticoagulation therapy-related complication in the subject;
d) determining any potential interaction of the anticoagulation agent with one or more non-anticoagulation agents;
e) evaluating in real time any need to adjust the anticoagulation regimen prescribed by the health care practitioner based on a determination made in one or both steps c) and d); and
f) adjusting in real time, if needed, the anticoagulation regimen to maintain the subject's International Normalized Ratio (INR) level within a desired range.

13. The method of claim 12, further comprising the step of:
g) obtaining from, or on behalf of, the subject an assent to acquire any and all one or more non-anticoagulation agents that the subject intends to take or is taking.

14. The method of claim 12, further comprising the step of:
g) conducting, prior to step e), a blood test to determine whether the INR level for the subject is sub-therapeutic, therapeutic, or supra-therapeutic.

15. The method of claim 14, wherein:
the step f) of adjusting the anticoagulation regimen comprises providing a supplemental anticoagulation agent, if the INR level is sub-therapeutic.

16. The method of claim 14, wherein:
the step f) of adjusting the anticoagulation regimen comprises reversing anticoagulation therapy, if the INR level is supra-therapeutic.

17. The method of claim 12, wherein:
the step c) of assessing any sign or symptom comprises assessing one or more of the following:
i) sign or symptom of hemorrhage, bleeding, and/or bruising;
ii) sign or symptom of thromboembolism;
iii) change in a condition requiring anticoagulation therapy;
iv) alteration in diet, medication, and/or alcohol intake;
v) recent alteration in a medical condition or illness;
vi) any complication relating to the anticoagulation agent; and
vii) compliance with anticoagulation therapy.

18. The method of claim 13, wherein:
the non-anticoagulation agent comprises at least one member selected from the group consisting of prescription medication, over-the-counter (OTC) medication, dietary supplement, herbal medication, herbal supplement, vitamin, mineral, food item, and a combination thereof.

19. The method of claim 12, wherein:
the step f) of adjusting the anticoagulation regimen is carried out at the discretion of the point-of-sale establishment.

20. The method of claim 12, wherein:
the point-of-sale establishment comprises a retail pharmacy.

21. A retail pharmacist-managed, anticoagulation agent therapy method for a subject, the method comprising the steps of:
a) reviewing an anticoagulation regimen prescribed by a health care practitioner for a subject;
b) enrolling the subject into an anticoagulation therapy program, the program including dispensing of an anticoagulation agent, as well as one or more non-anticoagulation agents that the subject intends to take or is taking while in the program;
c) conducting a test to determine whether an International Normalized Ratio (INR) level for the subject is sub-therapeutic, therapeutic, or supra-therapeutic;
d) assessing any sign or symptom of anticoagulation therapy-related complication in the subject;
e) determining any potential interaction of the anticoagulation agent with one or more non-anticoagulation agents;
f) evaluating in real time any need to adjust the anticoagulation regimen prescribed by the health care practitioner based on a determination made in one or more steps c), d) and e); and
g) adjusting in real time, if needed, at the discretion of the pharmacist, the anticoagulation regimen to maintain the subject's INR level within a desired range.

22. The method of claim 21, further comprising the step of:
h) obtaining from, or on behalf of, the subject an assent to acquire any and all one or more non-anticoagulation agents that the subject intends to take or is taking.

23. The method of claim 22, wherein:
the anticoagulation agent comprises at least one member selected from the group consisting of warfarin, Factor Xa inhibitor, antiplatelet drug, Aspirin®, and a combination thereof.

24. The method of claim 23, wherein:
the step g) of adjusting the anticoagulation regimen comprises providing a supplemental anticoagulation agent, if the INR level is sub-therapeutic.

25. The method of claim 24, wherein:
the supplemental agent comprises at least one member selected from the group consisting of heparin, low molecular weight heparin, and a combination thereof.

26. The method of claim 25, wherein:
the low molecular weight heparin comprises at least one member selected from the group consisting of enoxaparin, dalteparin, fondaparinux, and a combination thereof.

27. The method of claim 23, wherein:
the step g) of adjusting the anticoagulation regimen comprises reversing anticoagulation therapy, if the INR level is supra-therapeutic.

28. The method of claim 27, wherein:
reversing of anticoagulation therapy is achieved by administering one or more suitable doses of Vitamin K, or holding one or more anticoagulation agent doses.

29. The method of claim 21, wherein:
the step d) of assessing anticoagulation therapy-related complication comprises determining any complication relating to the anticoagulation agent.

30. A method for point-of-dispensing management of an anticoagulation agent therapy for a subject, the subject having already been enrolled in a therapy program, the method comprising the steps of:
a) determining an International Normalized Ratio (INR) level for the subject;
b) determining any potential interaction of the anticoagulation agent with one or more non-anticoagulation agents that the subject intends to take or is taking;
c) evaluating in real time any need to adjust the anticoagulation therapy based on a determination made in one or both steps a) and b); and
d) adjusting in real time, if needed, the anticoagulation therapy to maintain the subject's INR level within a desired range.

31. The method of claim 30, wherein:
the point-of-dispensing comprises a retail pharmacy.

32. In a point-of-sale establishment, a method of managing an anticoagulation agent therapy for a subject, the subject having already been enrolled in a therapy program, the method comprising the steps of:
a) assessing any sign or symptom of anticoagulation therapy-related complication in the subject;
b) determining in real time any potential interaction of the anticoagulation agent with one or more non-anticoagulation agents that the subject intends to take or is taking;
c) evaluating in real time any need to adjust the anticoagulation therapy based on a determination made in one or both steps a) and b); and
d) adjusting in real time, if needed, the anticoagulation therapy to maintain the subject's International Normalized Ratio (INR) level within a desired range.

33. The method of claim 32, wherein:
the step a) of assessing anticoagulation therapy-related complication comprises determining any complication relating to the anticoagulation agent.

34. The method of claim 32, wherein:
the point-of-sale establishment comprises a retail pharmacy.

35. The method of claim 32, wherein:
the step d) of adjusting the anticoagulation therapy is carried out at the discretion of the point-of-sale establishment.
